(19) United States
(12) Patent Application Publication
(10) Pub. No.: US 2018/0079852 A1
(43) Pub. Date: Mar. 22, 2018

(54) POLYISOCYANATE COMPOSITION BASED ON 1,5-PENTAMETHYLENE DIISOCYANATE

(71) Applicant: Covestro Deutschland AG, Leverkusen (DE)

(72) Inventors: Andreas Hecking, Langenfeld (DE); Christoph Eggert, Köln (DE); Uwe Werner, Köln (DE); Nusret Yuva, Burscheid (DE); Gesa Behnken, Köln (DE); Robert Reyer, Langenfeld (DE)

(21) Appl. No.: 15/557,997

(22) PCT Filed: Mar. 14, 2016
(86) PCT No.: PCT/EP2016/055440

§ 371 Date: Sep. 13, 2017

(30) Foreign Application Priority Data
Mar. 16, 2015 (EP) 15159291.2

(51) Int. Cl. C08G 18/09; C08G 18/73; C09D 175/06; C08G 18/78

(52) U.S. Cl. CPC C08G 18/092; C08G 18/7837; C09D 175/06; C08G 18/73

(57) ABSTRACT

The invention relates to a polyisocyanate composition, containing compounds having isocyanate groups with at least one 1,5-bridging pentamethylene unit and an isocyanate group, wherein a portion of the compounds additionally has at least one allophanate group, characterized in that the polyisocyanate composition has an isocyanurate trimer content of ≦59 wt. % in relation to the total weight of the polyisocyanate composition, the allophanate groups carry a group that is organic and inert relative to isocyanate groups, and the allophanate groups are present in an equivalent ratio of >0 and ≦0.19 in relation to the isocyanurate groups. The invention also relates to a method for producing the polyisocyanate, a two-component system, the use thereof for the production of a coating on a substrate, the coating and the composite formed by the coating and the substrate.

### CROSS REFERENCE TO RELATED APPLICATIONS

This application is a national stage application under 35 U.S.C. § 371 of PCT/EP2016/055440, filed Mar. 14, 2016 which claims benefit of European Application No. 15159291.2, filed Mar. 16, 2015 and which are incorporated by reference herein.

### FIELD OF THE INVENTION

The invention relates to a polyisocyanate composition comprising compounds containing isocyanate groups and having at least one 1,5-bridging pentamethylene unit and an isocyanurate group, with some of the compounds additionally having at least one allophanate group as well. A further subject of the invention is a process for producing such a polyisocyanate composition. Furthermore, a two-component system comprising the polyisocyanate composition, the use of said system for producing a coating on a substrate, and the assembly composed of the coating and the substrate are further subjects of the invention.

### BACKGROUND OF THE INVENTION

Two-component polyurethane coatings are long-established. For high-quality lightfast topcoat materials, coatings employed are, in particular, those formed from aliphatic polyisocyanates and polyols such as polyacrylate polyols, polyester polyols or polycarbonate polyols, for example. Polyisocyanates employed for these high-quality coatings are, in particular, low-monomer derivatives prepared from hexamethylene 1,6-diisocyanate (HDI). Particularly suitable for elastic, highly robust coatings for this purpose are isocyanurate polyisocyanates of HDI, or HDI polyisocyanates containing iminooxadiazinedione and isocyanurate structures, as are described for example in H. J. Laas, R. Halpaap, J. Pedain, J. prakt. Chem. 1994, 336, 185-200 or in EP 0330966 B1 or EP 0798299 B1. These polyisocyanates generally have isocyanate functionalities (F_{NCO}) of 3 or more, where isocyanate functionality refers to the average number of NCO groups per molecule.

The processing of coating systems of these kinds is described for example in H.-U. Meier-Westhues, Polyurethane-Lacke, Kleb- and Dichtstoffe, Hannover Vincentz Network 2007 on pages 72 ff. While not only the raw materials such as polyisocyanates but also the polyols as reaction partners, and the processing technology as well, have undergone continual onward optimization, there remain a number of fundamental interrelationships and dependencies. Thus the various derivatives of the respective polyisocyanates have a limited spectrum of polarity. The known polyisocyanurates of HDI represent the weakly polar region. In the case of the HDI polyisocyanurates, there are also biuret structures known, which in terms of their polarity are distinctive from the polyisocyanurate structures.

Particularly with increasing requirements regarding the robustness of a coating system, in terms of the weather resistance and chemical resistance, for example, coupled with high abrasion resistance, gloss retention, and lightfastness, the user is reliant, on the binder side, on systems with high OH group content. On account of their chemical composition, such systems possess increased polarity relative to standard binders. The skilled person is aware that these polarity differences between the binder and the polyisocyanate in the applied coating systems lead to considerable losses in gloss, which can be overcome only to a limited extent by using additives.

The parameters employed in order to characterize OH-group-containing binders intended for crosslinking of polyisocyanates include, among others, in particular their hydroxyl group content. This parameter can be reported in terms of mass of hydroxyl groups per 100 g solids content of the binder (wt %). As a rough scaling of the binders for the purposes of the skilled person, hydroxyl group contents ≧5.0 wt % are generally considered incompatible with polyisocyanurates based on HDI. In the text below, binders having a hydroxyl group content ≧5.0 wt % are also referred to as compounds with high OH group content.

In the area of the binders with high OH group content, the user is reliant on the use of crosslinkers containing biuret structures, on account of an incompatibility with the polyisocyanurates, which is known to the skilled person. The biuret derivatives of HDI that have been used to date for crosslinking with polar binders have a low reactive NCO group content, as a result of their structure, and have an increased viscosity relative to other derivatives, and therefore fail to meet in every aspect the requirements desired for a modern coating technology.

As well as HDI, pentamethylene 1,5-diisocyanate (PDI) is another long-known monomer, having been described for example by W. Siefken, Liebigs Ann. Chem. 1949, 562, page 122 or in DE 1493360 B1 and DE 1900514 A1. The effect of polyisocyanurates containing allophanate groups, and their compatibility, are pointed out by P. B. Jacobs; H. Mertes; R. S. Dearth in their article in European Coatings Journal, No. 9, pages 594-600, 1996, Cycloaliphatic AMT polyisocyanates and their blends. In tables 3, 4 and 6 on pages 263 and 264, allophanate-group-modified trimers (AMT) and also polyisocyanurates based on HDI are compared with one another. In none of the formulations described do the AMT compounds set themselves apart from the standard HDI polyisocyanurates in respect of gloss.

EP 2543736 A1 describes the fermentative operation of obtaining 1,5-pentanediamine from lysine. Also disclosed are polyisocyanates, starting from pentamethylene 1,5-diisocyanate, which may have isocyanurate, allophanate, biuret, urethane and urea groups. But EP 2543736 A1 does not disclose polyisocyanates distinguished by improved compatibility over binders of high OH group content. The catalyst that is described and used exclusively in this specification results—as is also described in EP 1091991 B1—in an isocyanurate trimer having high derivative purity. While this derivative does have a relatively high reactive NCO group content, there is no description of a compatibility with respect to polar binders that is improved by comparison with an HDI-based polyisocyanurate.

EP 0524500 A1 and EP 0524501 A1 disclose polyisocyanates starting from aliphatic diisocyanates having 4 to 18 carbon atoms, preferably from HDI, with a ratio of allophanate groups to isocyanurate groups of >0.1 and <5, and point to an improved compatibility in the case of allophanate-containing polyisocyanates. Unresolved, however, is the extent to which pure isocyanurate-containing polyisocyanates are different in their compatibility from those containing allophanate groups, since neither of the stated specifications discloses experiments providing comparison in this respect.

JP 2007-112936 A discloses an aliphatic polyisocyanate having an isocyanurate trimer content of 60 to 95 wt %, based on the total amount of polyisocyanate, and describes a content of below 60 wt % as being disadvantageous for the viscosity and hence deleterious for the usefulness of such a polyisocyanate.

It continued to be desirable, therefore, to be able to provide a crosslinker which comprises predominantly polyisocyanurate structures, is compatible over a broad spectrum with compounds of high OH group content, and is not hampered by restrictions on usefulness in, for example, two-component polyurethane coating systems.

### SUMMARY OF THE INVENTION

The present invention provides a polyisocyanate composition based on pentamethylene 1,5-diisocyanate which exhibits significantly improved compatibility with respect to binders of high OH group content by comparison with the state of the art.

These and other advantages and benefits of the present invention will be apparent from the Detailed Description of the Invention herein below.

### DETAILED DESCRIPTION OF THE INVENTION

The present invention will now be described for purposes of illustration and not limitation.

The present invention provides a polyisocyanate composition comprising compounds containing isocyanate groups and having at least one 1,5-bridging pentamethylene unit and an isocyanurate group, with some of the compounds additionally having at least one allophanate group as well, characterized in that the polyisocyanate composition has an isocyanurate trimer content of <59 wt %, based on the total weight of the polyisocyanate composition, the allophanate groups carry an organic radical which is inert towards isocyanate groups, and the equivalent ratio of the allophanate groups to the isocyanurate groups is >0 and <0.19.

Surprisingly it has now been found that the polyisocyanate composition of the invention is distinguished relative to the state of the art by improved compatibility with compounds having, with particular preference, high OH group content, and can be formulated very well to give two-component systems. The coatings obtainable from the two-component systems are notable for a significantly improved gloss relative to the state of the art, while retaining very good physicochemical properties. Furthermore, the polyisocyanate composition of the invention is notable for low viscosity and a high reactive NCO group content.

Understood presently by 1,5-bridging pentamethylene units are structural units which consist of linear pentamethylene units (—CH₂CH₂CH₂CH₂CH₂—) which are connected at position 1 to the nitrogen atom of an isocyanate group, to the nitrogen atom of an isocyanurate group or to the nitrogen atom of an allophanate group which carries an organic radical inert toward isocyanate groups, and which are connected at position 5 to the nitrogen atom of an isocyanurate group or to the nitrogen atom of an allophanate group which carries an organic radical inert toward isocyanate groups. The designation of the 1 and 5 positions here may also be switched.

For the purposes of the present invention, trimer structures are understood as the following isocyanurate structural units, linked randomly to one another in accordance with the oligomeric distribution via the above-described pentamethylene units:

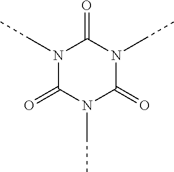

### Isocyanurate Group

The statement of the isocyanurate trimer content as a weight fraction based on the total weight of the polyisocyanate composition refers in accordance with the invention to the compounds in the polyisocyanate composition that comprise exactly one isocyanurate group and three isocyanate groups.

Allophanate groups are understood presently as the following structural units:

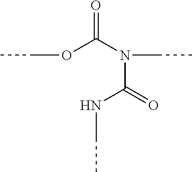

### Allophanate Group

The stated allophanate groups are incorporated randomly during the trimerization process into the oligomer distribution of the isocyanurates.

For the purposes of the present invention, high compatibility between NCO-functional crosslinking agent and the polyisocyanate composition of the invention is understood to mean that the two components, together in suitable solvents, form homogeneous solutions, and in particular during film formation form homogeneous films by diffusion processes, and do not separate. Any inhomogeneity during film formation results in disruptions in the surface, leading in turn to deviations in the ratio between irradiated light and light reflected from the surface. The ratio between irradiated light and light reflected from the surface at the angle of specular reflection is stated as gloss for the description of planar surfaces. Gloss measurement is an established measure of the compatibility of coating systems. The gloss was measured using a reflectometer in accordance with DIN EN ISO 2813 at the 20° and 60° angles.

In a first preferred embodiment, the isocyanurate trimer content is <56 wt %, preferably <51 wt %, and more preferably <47 wt %, based on the total weight of the polyisocyanate composition of the invention.

The isocyanurate trimer content may be determined, for example, by gel permeation chromatography according to DIN 55672-1.

According to a further preferred embodiment, the equivalent ratio of the allophanate groups to the isocyanurate groups is between >0.02 and <0.18, preferably between >0.05 and <0.16, and more preferably between >0.10 and <0.15. One of the advantages of this is that it is possible further to boost the resource efficiency relative to a pure allophanate, thereby supporting the fundamental aim for an environmentally and economically optimized formation. By comparison with pure polyisocyanurates, the amount of reactive NCO groups falls as the fraction of allophanate groups goes up, thereby raising the amount of curing agent to be used relative to the binder, which in turn necessitates an increase in the quantity of solvent.

The equivalent ratio of allophanate groups to the isocyanurate groups may be determined, for example, by NMR-spectroscopic analysis. Preferably here it is possible to use ¹³C NMR spectroscopy, preferably proton-decoupled, since the allophanate, isocyanurate and/or uretdione groups yield characteristic signals. The chemical shift of the abovementioned compounds in the NMR spectrum is known in the literature (cf. D. Wendisch, H. Reiff and D. Dieterich, Angew. Makromol. Chem. 1986, 141, 173-183 and literature cited therein).

A combination of the two above-stated embodiments may be particularly advantageous if employing binders having an OH content >7.0 wt % as NCO-functional crosslinking agents, since in this case the compatibility is particularly high.

In a further preferred embodiment, the organic radical that is inert toward isocyanate groups is selected from the group of linear, branched and optionally substituted radicals having 1 to 18 carbon atoms, preferably having 1 to 12 carbon atoms, and more preferably having 1 to 8 carbon atoms.

In respect of the polyisocyanate composition of the invention it is likewise preferred if the organic radical is connected via a primary or secondary, preferably via a primary, carbon atom to the allophanate group.

Suitable organic radicals are, for example, methyl, ethyl, 1-propyl, 2-propyl, n-butyl, isobutyl, sec-butyl, n-hexyl, 2-ethyl-1-hexyl, and also the ether alcohols stated below and reacted to form an allophanate group, such as, for example, 1-methoxy-2-propanol, 3-ethyl-3-hydroxymethyloxetane, tetrahydrofurfuryl alcohol, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, or else higher-molecular-mass liquid polyethylene glycol monoalkyl ethers, polypropylene glycol monoalkyl ethers, mixed polyethylene/polypropylene glycol monoalkyl ethers; ester alcohols, such as, for example, ethylene glycol monoacetate, propylene glycol monolaurate, glycerol diacetate, 2,2,4-trimethyl-1,3-pentanediol monoisobutyrate; unsaturated alcohols such as allyl alcohol, 1,1-dimethylallyl alcohol or oleyl alcohol, for example; araliphatic alcohols such as benzyl alcohol.

According to a further preferred embodiment, the polyisocyanate composition of the invention has an isocyanate group content of between >15% and <25%, preferably between >17% and <24%, and more preferably between >20% and <23%, based on the total weight of the polyisocyanate composition of the invention.

This isocyanate group content may also be designated NCO content and may be determined for example by titration in accordance with DIN EN ISO 11 909.

It is further particularly preferred for the residual pentamethylene 1,5-diisocyanate monomer content in the polyisocyanate composition of the invention to be below 0.5 wt %, preferably below 0.3 wt %. The residual monomer contents may be determined for example by gas chromatography according to DIN EN ISO 10283.

In a further preferred embodiment, the polyisocyanate composition of the invention according to DIN EN ISO 3219 at 23° C. has a viscosity of <36 000 mPa*s, preferably of <24 000 mPa*s, and more preferably of <12 000 mPa*s.

The viscosity may be determined in accordance with DIN EN ISO 3219, for example, at 23° C. using the VT 550 viscometer from Haake.

Employed as isocyanate component when producing the polyisocyanate composition of the invention is at least pentamethylene 1,5-diisocyanate, which is mixed with at least one linear, branched, and optionally substituted monoalcohol that is inert toward isocyanate groups in the side chain, and which is reacted in the presence of a catalyst to give the polyisocyanate composition. A process of this kind is therefore a further subject of the present invention.

In one preferred embodiment, the isocyanate component for carrying out the process of the invention may be introduced, optionally under inert gas, such as nitrogen, for example, and optionally in the presence of a solvent, at a temperature between 0 and 180° C., preferably 20 to 140° C., more preferably 40 to 100° C.

After the isocyanate component has been introduced, the catalyst, or a mixture of the catalyst with a suitable catalyst solvent, may be added in the quantity indicated below. The catalyst here may be added in one or more portions or else continuously, by means of a suitable metering pump, for example, throughout the reaction time.

Particularly suitable for use in the process of the invention, as linear, branched, and optionally substituted monoalcohols which are inert in the side chain toward isocyanate groups, are monoalcohols which have 1 to 18 carbon atoms, preferably having 1 to 12 carbon atoms, and more preferably having 1 to 8 carbon atoms.

With particular preference the monoalcohols used are primary or secondary, especially preferably primary, monoalcohols.

Suitable monoalcohols for the process of the invention are, for example, methanol, ethanol, n-propanol, isopropanol, n-butanol, sec-butanol, isobutanol, n-hexanol, 2-ethyl-1-hexanol ether alcohols, such as, for example, 1-methoxy-2-propanol, 3-ethyl-3-hydroxymethyloxetane, tetrahydrofurfuryl alcohol, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, or else higher-molecular-mass liquid polyethylene glycol monoalkyl ethers, polypropylene glycol monoalkyl ethers, mixed polyethylene/polypropylene glycol monoalkyl ethers; ester alcohols, such as, for example, ethylene glycol monoacetate, propylene glycol monolaurate, glycerol diacetate, 2,2,4-trimethyl-1,3-pentanediol monoisobutyrate; unsaturated alcohols such as allyl alcohol, 1,1-dimethylallyl alcohol or oleyl alcohol, for example; araliphatic alcohols such as benzyl alcohol.

The temperatures for carrying out the process of the invention may be selected in dependence on the compounds used. In this case, however, it is preferred if the reaction is carried out at temperatures between >0 and <180° C., preferably >20 to <140° C., more preferably >40 to <100° C.

The pentamethylene 1,5-diisocyanate used in the process of the invention may be generated by any desired processes known in the prior art for the preparation of aliphatic diisocyanates, with or without using phosgene, for example, and starting from 1,5-diaminopentane, preferably obtained biotechnologically through decarboxylation of the naturally occurring amino acid lysine. When using phosgene, the phosgenation of 1,5-diaminopentane may take place in the liquid phase or gas phase.

It is particularly preferred here for the process of the invention if 1,5-diisocyanatopentane is obtained by phosgenation of 1,5-diaminopentane in the gas phase. The gas-phase phosgenation of amines is known and may take place for example as described in EP 0 289 840 B1, EP 1 319 655 A2, EP 1 555 258 A1, EP 1 275 639 A1, EP 1 275 640 A1, EP 1 449 826 A1, EP 1 754 698 B1, DE 10 359 627 A1 or in German patent application DE 10 2005 042392 A1.

The nature of the trimerization catalyst plays a part in the conduct of the process of the invention insofar as it may influence the product selectivity in relation to the formation of products containing predominantly allophanate and isocyanurate groups.

A range of compounds have established themselves as catalysts for the modification of isocyanates, as described for example in H. J. Laas et al., J. Prakt. Chem. 1994, 336, 185 ff, D. Dieterich Methoden der organischen Chemie (Houben-Weyl), Volume E 20 1987, 1741 ff, EP 0649866 A1 (page 4, line 7 to page 5, line 15) or EP 0896009 A1 (page 4, lines 17 to 58).

Suitable catalysts are, for example, quaternary ammonium carboxylates, such as, for example, N-(2-hydroxypropyl)-N,N,N-trimethylammonium-2-ethylhexanoate, N-(2-hydroxypropyl)-N,N,N-trimethylammonium-2-formate, N,N,N-tetramethyl ammonium octoate, quaternary ammonium hydroxides, such as, for example, tetramethyl-, tetraethyl-, trimethylstearyl-, and dimethylethylcyclohexyl-ammonium hydroxide, N,N,N-trimethyl-N-(2-hydroxyethyl)ammonium hydroxide, N,N,N-trimethyl-N-(2-hydroxypropyl)ammonium hydroxide, N,N,N-trimethyl-(2-hydroxybutyl)ammonium hydroxide, N,N-dimethyl-n-dodecyl-N-(2-hydroxyethyl)ammonium hydroxide, N-(2-hydroxyethyl)-N,N-dimethyl-N-(2,2′-dihydroxymethylbutyl)ammonium hydroxide, N-methyl-2-hydroxyethylmorpholinium hydroxide, N-methyl-N-(2-hydroxypropyl)pyrrolidinium hydroxide, N-dodecyl-tris-N-(2-hydroxyethyl)ammonium hydroxide, tetra(2-hydroxyethyl)ammonium hydroxide, N,N,N-trimethyl-N-benzylammonium hydroxide, or quaternary ammonium and phosphonium hydrogen polyfluorides, such as tetrabutylphosphonium hydrogen difluoride. Especially preferred catalysts of this group are N,N,N-trimethyl-N-(2-hydroxyethyl)ammonium hydroxide, N,N,N-trimethyl-N-(2-hydroxypropyl)ammonium hydroxide, N,N,N-trimethyl-N-(2-hydroxybutyl)ammonium hydroxide, and, in particular, N,N,N-trimethyl-N-benzylammonium hydroxide.

Catalysts likewise suitable are, for example, hexamethyldisilazane, heptamethyldisilazane, 1,3-diethyl-1,1,3,3-tetramethyldisilazane, 1,3-divinyl-1,1,3,3-tetramethyldisilazane, hexaethyldisilazane and 1,3-diphenyl-1,1,3,3-tetramethyl disilazane. Of this group, hexamethyldisilazane is preferred.

Suitable amounts of the catalyst may be, for example, up to 0.25 wt %, preferably up to 0.1 wt %, and more preferably to 0.05 wt %.

In the process of the invention, catalyst solvents are preferably employed which carry groups reactive toward isocyanates and which can be incorporated into the polyisocyanate. Examples of such solvents are simple alcohols, such as, for example, methanol, ethanol, n-propanol, isopropanol, n-butanol, sec-butanol, isobutanol, n-hexanol, 2-ethyl-1-hexanol; ether alcohols, such as, for example, 1-methoxy-2-propanol, 3-ethyl-3-hydroxymethyloxetane, tetrahydrofurfuryl alcohol, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, or else higher-molecular-mass liquid polyethylene glycol monoalkyl ethers, polypropylene glycol monoalkyl ethers, mixed polyethylene/polypropylene glycol monoalkyl ethers; ester alcohols, such as, for example, ethylene glycol monoacetate, propylene glycol monolaurate, glycerol diacetate, 2,2,4-trimethyl-1,3-pentanediol monoisobutyrate; unsaturated alcohols such as, for example, allyl alcohol, 1,1-dimethylallyl alcohol or oleyl alcohol; araliphatic alcohols such as benzyl alcohol, for example; N-monosubstituted amides, such as N-methylformamide, N-methylacetamide, cyanoacetamide or 2-pyrrolidinone, for example, or any desired mixtures of such solvents.

It is especially preferred here if the catalyst is used in solution in the corresponding monoalcohol or monoalcohol mixture which is desired for the formation of the allophanate groups. In such cases the catalyst solvent then corresponds to the monoalcohols stated above. The sequence of addition of the components to be reacted is arbitrarily selectable. Where a catalyst in solution is used, the amount of the solvent may be selected such as to allow a defined equivalent ratio of the allophanate groups to the isocyanurate groups to be established.

Where highly dilute catalyst solutions in isocyanate-reactive catalyst solvents are used, there is a further problem: The intended (principal) reaction, the isocyanate modification, can indeed be terminated by earlier discontinuation of the reaction at lower conversion levels, but the reaction of the catalyst solvent with the free isocyanate groups of all the species present in the reaction cannot and continues to run at least up to the stage of the urethane (carbamate); generally, however, the desire is to take the conversion of the alcohol to the stage of the allophanate, which implies the presence of the active trimerization catalyst, which in the case claimed is also suitable and necessary for the formation of allophanate. Relative to the urethanes, which are constructed from the same building blocks, allophanate groups have better solubility in the polyisocyanate than the corresponding urethanes and have a much lower viscosity relative to the trimers—at least in the case of the products based on monofunctional alcohols. A disadvantage in principle, conversely, is that the allophanate groups constructed from monofunctional alcohols and diisocyanates are only NCO-difunctional and therefore lower the (average) NCO functionality of the polyisocyanates. The aim of this invention, therefore, was to balance the ratio between isocyanurate groups and allophanate groups to an optimum in the polyisocyanate composition of the invention.

A reaction mixture is understood hereinafter to refer to a mixture of pentamethylene 1,5-diisocyanate, the catalyst, the monoalcohol or monoalcohols, and also, optionally, further substances used, and the polyisocyanates formed.

In a further preferred embodiment, the course of reaction in the process of the invention is monitored via the decrease in the NCO content in the reaction mixture. Like the amount of isocyanate groups in the polyisocyanate composition obtained by the process of the invention, the isocyanate group content in the reaction mixture may be determined, for example, by titrimetry in accordance with DIN EN ISO 11 909.

According to a further preferred embodiment, the reaction is taken to a point where the reaction mixture has a degree of oligomerization of 10% to 40%, preferably of 15% to 30%. “Degree of oligomerization” presently refers to the percentage of the isocyanate groups originally present in the starting mixture that is consumed during the reaction according to the invention. The degree of oligomerization in percent can be calculated according to the following formula:

Degree of oligomerization=(NCO start−NCO end)/NCO start×100.

The reaction can be discontinued, for example, when the target degree of oligomerization has been reached. This degree of oligomerization is reached generally after a reaction time of 30 minutes to 8 hours, preferably of 1 to 6 hours.

The reaction may be terminated for example by cooling of the reaction mixture to room temperature. In general, however, the reaction is ended by addition of a catalyst poison and optional subsequent brief heating of the reaction mixture to a temperature above 80° C.

Examples of suitable catalyst poisons are inorganic acids such as hydrochloric acid, phosphorous acid or phosphoric acid, acyl chlorides such as acetyl chloride, benzoyl chloride or isophthaloyl dichloride, sulfonic acids and sulfonic esters, such as methanesulfonic acid, p-toluenesulfonic acid, trifluoromethanesulfonic acid, perfluorobutanesulfonic acid, dodecylbenzenesulfonic acid, methyl and ethyl p-toluenesulfonates, monoalkyl and dialkyl phosphates such as monotridecyl phosphate, dibutyl phosphate, and dioctyl phosphate, and also silylated acids, such as trimethylsilyl methanesulfonate, trimethylsilyl trifluoromethanesulfonate, tris(trimethylsilyl) phosphate, and diethyl trimethylsilyl phosphate.

The amount of catalyst poison needed to end the reaction is dependent here on the amount of catalyst used; in general, an equivalent amount of the catalyst poison is used, based on the catalyst used at the start. Taking account, though, of losses of catalyst possibly occurring during the reaction, just 20 to 80 equivalent % of the catalyst poison, based on the amount of catalyst originally used, may also be sufficient to end the reaction.

The stated catalyst poisons may be used either as they are or else in solution in a suitable solvent. If a solvent is employed for dissolving the catalyst poison, preference is given to pentane 1,5-diisocyanate. The degree of dilution may be selected freely within a very wide range; for example, suitability is possessed by solutions starting from a concentration of >25 wt %, preferably >10 wt %.

After the end of reaction, the reaction mixture is freed from volatile constituents (excess monomeric isocyanate components and any solvents additionally used) preferably by thin-film distillation under reduced pressure, as for example at a pressure of below 1.0 mbar, preferably below 0.75 mbar, more preferably below 0.25 mbar, under extremely gentle conditions, as for example at a temperature of 100 to 200° C., preferably of 120 to 180° C.

In another embodiment of the process of the invention, the stated volatile constituents are removed by extraction with suitable solvents that are inert toward isocyanate groups, examples being aliphatic or cycloaliphatic hydrocarbons such as pentane, hexane, heptane, cyclopentane or cyclohexane, from the polyisocyanate composition of the invention.

The polyisocyanate composition of the invention is outstandingly suitable as a curing agent for two-component systems in which, for example, hydroxy-functional compounds, such as polyether polyols, polyester polyols, polycarbonate polyols and/or polyacrylate polyols, for example, are used as binders reactive toward isocyanate groups, as co-reactants for the polyisocyanate composition.

Alternatively to the hydroxy-functional compounds stated above, however, the polyisocyanate composition of the invention may also be combined with polyamines, such as the polyaspartic acid derivatives known from EP-B 0 403 921, for example, or else polyamines whose amino groups are present in blocked form, such as polyketimines, polyaldimines or oxazolanes. Forming from these blocked amino groups under the influence of moisture are free amino groups and, in the case of the oxazolanes, free hydroxyl groups as well, which are consumed in a crosslinking reaction with the isocyanate groups of the polyisocyanate composition of the invention.

Consequently a two-component system comprising a component A), comprising at least one polyisocyanate composition of the invention, and a component B), comprising at least one binder that is reactive toward isocyanate groups, is a further subject of the invention. The two-component system is also referred to below as coating composition.

According to a further preferred embodiment, the binder that is reactive toward isocyanate groups comprises at least one hydroxy-functional compound having a hydroxyl group content of >5.0 wt %, preferably of >7.0 wt %, and more preferably of >9.0 wt %, based on the solids content of the binder that is reactive toward isocyanate groups. Associated with this is the advantageous effect that a two-component system of this kind exhibits excellent compatibility and leads to coatings having further-improved physical properties.

The formulated coating composition may optionally be admixed with further auxiliaries and adjuvants customary in the coatings sector. Examples of auxiliaries and adjuvants suitable in this context include flow control assistants, color pigments, fillers, matting agents, organic or inorganic pigments, light stabilizers, coating additives such as dispersants, leveling agents, thickeners, defoamers, and other auxiliaries, bonding agents, fungicides, bactericides, stabilizers or inhibitors, and catalysts or emulsifiers.

In the production of the coating compositions from the polyisocyanate composition of the invention, the stated binders that are reactive toward isocyanate groups are used in general in amounts corresponding to an equivalent ratio of isocyanate groups that are reactive toward isocyanate groups of 2:1 to 0.5:1, preferably of 1.5:1 to 0.8:1, more preferably of 1.1:1 to 0.9:1.

The mixing of the polyisocyanate composition of the invention with the binders that are reactive toward isocyanate groups may be accomplished by simple conjoint stirring prior to the processing of the coating compositions by any desired methods; by use of mechanical auxiliary agents known to the skilled person; or else using two-component spray guns.

In a further preferred embodiment, two-component systems above may give high-gloss, hard and elastic coatings, distinguished by outstanding solvent resistance, even upon room-temperature drying. It is, however, also possible for these 2-component systems to be dried under forced conditions at elevated temperature or by baking at temperatures up to 260° C.

As well as the above-described preferred use in nonblocked form, the polyisocyanate composition of the invention may alternatively be blocked, in the sense of one-component systems, with the blocking agents known from polyurethane chemistry. As blocking agents it is possible in this context to make use, generally, of the compounds described in H.-U. Meier-Westhues, Polyurethane-Lacke, Kleb- and Dichtstoffe, Hannover Vincentz Network 2007 on pages 36-43 or, for example, in EP 713871 A1.

In general the two-component systems of the invention can be used outstandingly for producing a coating on a substrate. A coating obtainable by using the two-component system of the invention is, therefore, a further subject of the present invention.

The coating compositions based on the polyisocyanate composition of the invention may be applied to any desired substrates by known methods such as, for example, by spraying, brushing, flow coating, or using rollers or doctor blades. Examples of suitable substrates are metal, wood, glass, stone, ceramic materials, concrete, rigid and flexible plastics, textiles, leather or paper, which may also have been optionally provided, prior to coating, with customary primers.

A further subject of the invention is an assembly composed of a coating of the invention and a substrate having a surface of metal and/or plastic.

Besides the coatings of the invention described, the polyisocyanate composition of the invention may also be used for producing moldings, adhesives, sealants, and casting elastomers.

The invention is elucidated in more detail hereinafter by examples.

### Examples

All quantity figures are based on mass unless otherwise noted.

The NCO content of the polyisocyanate compositions produced in the inventive and comparative examples was determined by titration in accordance with DIN EN ISO 11 909.

The residual monomer contents of the polyisocyanate compositions were determined by gas chromatography in accordance with DIN EN ISO 10283.

The dynamic viscosities were determined at 23° C. according to DIN EN ISO 3219 using the VT 550 viscometer from Haake. Measurements at different shear rates ensured that the flow behavior of the polyisocyanates described and of the comparative products corresponds to that of ideal Newtonian fluids. There is therefore no need for the shear rate to be reported.

The contents (mol %) and/or proportions of the isocyanurate and allophanate groups which form under the process conditions of the invention were computed from the integrals of proton-decoupled ¹³C-NMR spectra (recorded on a Bruker DPX-400 instrument) and relate in each case to the sum total of isocyanurate groups and allophanate groups present. Data for the chemical shift of the aforementioned compounds were taken from the literature (cf. D. Wendisch, H. Reiff and D. Dieterich, Angew. Makromol. Chem. 1986, 141, 173-183 and literature cited therein.

The isocyanurate trimer content was determined by gel permeation chromatography according to DIN 55672-1. The determination range of the column set used was in the range between 100 and 20000 Daltons. Evaluation took place by means of WIN GPC from Polymer Standard Services GmbH Mainz.

Chemicals Used

Dibutyl phosphate (Sigma Aldrich)

2-ethylhexan-1-ol (Sigma Aldrich)

Tetramethylammonium 2-ethylhexanoate (in-house synthesis from tetramethylammonium chloride and sodium 2-ethylhexanoate; Sigma Aldrich)

N,N,N-trimethyl-N-benzylammonium hydroxide (40% solution in methanol) (Sigma Aldrich)

Monochlorobenzene (Sigma Aldrich)

The following commercially available products were used for the compatibility tests in the use examples:

Butyl acetate, 1-methoxy-2-propyl acetate, and solvent naphtha light (Azelis Deutschland GmbH, Sankt Augustin)

DESMODUR N 3300, DESMODUR N 3790, DESMOPHEN 650 and also DESMOPHEN 775 XP (Covestro A G Leverkusen, D E)

### Polyisocyanate Composition 1 (Example 1, not Inventive)

A four-neck flask equipped with stirrer, reflux condenser, N₂ sparging tube and internal thermometer was charged with 1000 g (6.49 mol) of pentamethylene 1,5-diisocyanate (PDI), and degassed at room temperature and vented with nitrogen three times. The mixture was subsequently heated to 60° C. and 2.7 ml of the catalyst solution (tetramethylammonium 2-ethylhexanoate, 50% in monochlorobenzene) were metered in such a way as to maintain the exothermic trimerization at a temperature of 60-80° C. When an NCO content of 47.9 wt % was reached, the reaction was halted with dibutyl phosphate (equimolar amount based on tetramethylammonium octoate used) and the excess PDI was separated off via thin-film distillation at 140° C. and 0.5-0.6 mbar pressures. The resin obtained had an NCO content of 24.5% and a residual monomer content of 0.2%. The viscosity was 3 330 mPa·s at 23° C. The ratio of the 13C NMR integrals of the allophanate signals to isocyanurate signals (sum total allophanate/2:isocyanurate/3) was 0.

### Polyisocyanate Composition 2 (Example 2, Inventive)

A four-neck flask equipped with stirrer, reflux condenser, N₂ sparging tube and internal thermometer was charged with 1000 g (6.49 mol) of pentamethylene 1,5-diisocyanate (PDI), and degassed at room temperature and vented with nitrogen three times. The mixture was subsequently heated to 60° C. and 9.0 ml of the catalyst solution (1.5% N,N,N-trimethyl-N-benzylammonium hydroxide solution in methanol and 2-ethylhexanol) were metered in such a way as to maintain the exothermic trimerization at a temperature of 60-80° C. When an NCO content of 36.7 wt % was reached, the reaction was halted with dibutyl phosphate (equimolar amount based on trimethylbenzylammonium hydroxide used) and the excess PDI was separated off via thin-film distillation at 140° C. and 0.5-0.6 mbar pressures. The resin obtained had an NCO content of 21.7%, an isocyanurate trimer content of 41.2 wt %, and a residual monomer content of 0.3%. The viscosity was 10 000 mPa·s at 23° C. The ratio of the 13C NMR integrals of the (allophanate signals/2 to isocyanurate signals ((sum total of allophanate/2: isocyanurate/3)) was 0.12.

Compatibility Testing

For the testing for compatibility, the stated polyisocyanate compositions were reacted in use Example 3 with DESMOPHEN 650 (OH % content 8.5±0.4, based on the solids content of the polyol) and in application Example 4 with DESMOPHEN 775 XP (OH % content 12.5±0.5, based on the solids content of the binder). The polyesters used are notable for outstanding lightfastness, gloss retention, and weather resistance, and possess very good chemical resistance and also high abrasion resistance. The HDI polyisocyanate compatibility stated in the manufacturer's product data sheet is limited to polyisocyanates containing biuret structures (DESMODUR N75, DESMODUR N100, and DESMODUR N3200).

Crosslinkers of the invention used were the polyisocyanate composition obtained from Example 2, based on PDI, and comparative examples used were the polyisocyanurate obtained from the noninventive Example 1, based on PDI, and also the standard HDI-based polyisocyanurates from Covestro AG, DESMODURN 3300 and DESMODUR N 3790.

The formulations, without additives and catalysts, in an NCO to OH ratio of 1.1:1, were adjusted in a dilution with approximately 30-second efflux time in the DIN 4 cup. For the efflux time adjustment, a methoxypropyl acetate/butyl acetate/solvent naphtha 100 solvent mixture (in 1:1:1 ratio) was used. The crosslinked coating system was processed by spray application, and applied to Erichsen 24/5 test charts for measurement of the gloss values. Drying took place a) by drying at room temperature (23° C. at 50% relative humidity) or b) by flashing off at room temperature for 15 minutes and baking at 80° C. for 30 minutes. The gloss was measured according to DIN EN ISO 2813 at the 20° and 60° angles by means of a reflectometer (Byk Gardner micro haze plus). The results of the performance investigations are summarized in Tables 1 and 2.

The compatibility of a coating system, i.e., of the binder with the curing agent, can be described as a function of the gloss. If there is inhomogeneity during film formation, it results in defects in the surface, which lead in turn to deviations in the ratio between irradiated light and light reflected from the surface. Stated deviations in the ratio of the irradiated light to the light reflected from the surface can be determined by refractometric gloss measurement. At the 60° angle, gloss units (GU) of 70 to 100 GU are considered as high-gloss, gloss units between 45 and 70 GU as satin-gloss and between 20 to 45 GU as silk-matt. The 60° geometry is highly suitable for the measurement of a wide gloss range. Visually perceptible differences in degree of gloss are differentiated sufficiently to well. In the high-gloss range of >70 GU at 60°, the 20° geometry is more suitable, since differences in degree of gloss at 60° can no longer be clearly distinguished.

TABLE 1
Use Example 3

| | Polyester/curing agent combination | | | | | |
|---|---|---|---|---|---|---|
| | Desmophen ® 650 MPA | | Desmophen ® 650 MPA | | Desmophen ® 650 MPA | |
| | Desmodur ® N3300 | | Demodur ® N 3790 BA | | inventive example 2 | |
| Drying conditions | RT | 30′/80° C. | RT | 30′/80° C. | RT | 30′/80° C. |
| Gloss 20°/60° [GU] | 13/43 | 19/60 | 19/63 | 45/80 | 90/96 | 85/96 |

As evident in Table 1, inventive Example 2 exhibits a significantly higher gloss at both the 60° and 20° angles. Complete compatibility can therefore be assumed between the binder of high OH group content that is used here (DESMOPHEN 650, 8.5 wt % OH content, based on the solids content of the binder) and the polyisocyanate composition of the invention based on pentane 1,5-diisocyanate. In contrast to this, the two coating systems in which polyisocyanurates of HDI with the DESMOPHEN 650 binder were applied exhibit unambiguously lower gloss values at both measurement angles, thus revealing deficient compatibility of these systems.

TABLE 2
Use Example 4

| | Polyester/curing agent combination | | | |
|---|---|---|---|---|
| | Desmophen ® 775 XP: | | Desmophen ® 775 XP: | |
| | noninventive example 1 | | inventive example 2 | |
| Drying conditions | RT | 30′/80° C. | RT | 30′/80° C. |
| Gloss 20°/60° [GU] | 15/46 | 16/49 | 46/85 | 74/92 |

From Table 2 of Use Example 4 it is evident that inventive Example 2 also displays a clear advantage over the noninventive Example 1 when in combination with the polyester of very high OH group content, DESMOPHEN 775 XP (12.5 wt % OH content, based on the solids content of the binder) in terms of the gloss measurements. In the measurement at the 60° angle, inventive Example 2 achieves gloss units which according to DIN EN ISO 2813 require further assessment at the 20° angle. In the case of the noninventive Example 1, in contrast, the measurement at the 60° angle already shows an incompatibility, on the basis of the low gloss units, meaning that measurement at the 20° angle is unnecessary and is informative only in character.

In summary, the performance results show that the polyisocyanate composition of the invention exhibits improved compatibility in relation to binders with high OH-group content.

Various aspects of the subject matter described herein are set out in the following numbered clauses:

1. A polyisocyanate composition comprising compounds containing isocyanate groups and having at least one 1,5-bridging pentamethylene unit and an isocyanurate group, with some of the compounds additionally having at least one allophanate group as well, characterized in that the polyisocyanate composition has an isocyanurate trimer content of <59 wt %, based on the total weight of the polyisocyanate composition, the allophanate groups carry an organic radical which is inert towards isocyanate groups, and the equivalent ratio of the allophanate groups to the isocyanurate groups is >0 and <0.19.

2. The polyisocyanate composition as in clause 1, characterized in that the isocyanurate trimer content is <56 wt %, preferably <51 wt %, and more preferably <47 wt %, based on the total weight of the polyisocyanate composition.

3. The polyisocyanate composition as in either of clauses 1 and 2, characterized in that the equivalent ratio is between >0.02 and <0.18, preferably between >0.05 and <0.16, and more preferably between >0.10 and <0.15.

4. The polyisocyanate composition as in any of clauses 1 to 3, characterized in that the organic radical is selected from the group of linear, branched, and optionally substituted radicals having 1 to 18 carbon atoms, preferably having 1 to 12 carbon atoms, and more preferably having 1 to 8 carbon atoms.

5. The polyisocyanate composition as in any of clauses 1 to 4, characterized in that the organic radical is connected via a primary or secondary, preferably via a primary, carbon atom to the allophanate group.

6. The polyisocyanate composition as in any of clause 1 to 5, characterized in that it has an isocyanate group content of between >15% and <25%, preferably between >17% and <24%, and more preferably between >20% and <23%, based on the total weight of the polyisocyanate composition of the invention.

7. The polyisocyanate composition as in any of clauses 1 to 6, characterized in that according to DIN EN ISO 3219 at 23° C. it has a viscosity of <36 000 mPa·s, preferably of <24 000 mPa·s, and more preferably of <12 000 mPa·s.

8. A process for producing a polyisocyanate composition as in any of clauses 1 to 7, characterized in that at least 1,5-diisocyanatopentane is mixed with at least linear, branched, and optionally substituted monoalcohol which is inert in the side chain toward isocyanate groups, and reaction is carried out in the presence of a catalyst to give the polyisocyanate composition.

9. The process as in clause 8, characterized in that the reaction is carried out at temperatures between >0 and <180° C., preferably >20 to <140° C., more preferably >40 to <100° C.

10. The process as in either of clauses 8 and 9, characterized in that the 1,5-diisocyanatopentane is obtained by phosgenation of 1,5-diaminopentane in the gas phase.

11. A two-component system comprising a component A), comprising at least one polyisocyanate composition as in any of clauses 1 to 7, and a component B), comprising at least one binder that is reactive toward isocyanate groups.

12. The two-component system as in clause 11, characterized in that the binder that is reactive toward isocyanate groups comprises at least one hydroxy-functional compound having a hydroxyl group content of >5.0 wt %, preferably of >7.0 wt %, and more preferably of >9.0 wt %, based on the solids content of the binder that is reactive toward isocyanate groups.

13. The use of the two-component system as in either of clauses 11 and 12 for producing a coating on a substrate.

14. A coating obtainable by use of the two-component system as in clause 13.

15. An assembly composed of a coating as in clause 14 and a substrate having a surface of metal and/or plastic.

1. A polyisocyanate composition comprising compounds containing isocyanate groups and having at least one 1,5-bridging pentamethylene unit and an isocyanurate group, with at least a portion of the compounds additionally having at least one allophanate group as well, wherein the polyisocyanate composition has an isocyanurate trimer content of ≦59 wt %, based on the total weight of the polyisocyanate composition, the allophanate groups carry an organic radical which is inert towards isocyanate groups, and the equivalent ratio of the allophanate groups to the isocyanurate groups is >0 and ≦0.19.

2. The polyisocyanate composition according to claim 1, wherein the isocyanurate trimer content is ≦56 wt %, based on the total weight of the polyisocyanate composition.

3. The polyisocyanate composition according to claim 1, wherein the equivalent ratio is between ≧0.02 and ≦0.18.

4. The polyisocyanate composition according to claim 1, wherein the organic radical is selected from the group consisting of linear, branched, and optionally substituted radicals having 1 to 18 carbon atoms, 1 to 12 carbon atoms, and 1 to 8 carbon atoms.

5. The polyisocyanate composition according to claim 1, wherein the organic radical is connected via a primary or secondary carbon atom to the allophanate group.

6. The polyisocyanate composition according to claim 1, having an isocyanate group content of between ≧15% and ≦25%, based on the total weight of the polyisocyanate composition of the invention.

7. The polyisocyanate composition according to claim 1, a viscosity of ≦36 000 mPa*s according to DIN EN ISO 3219 at 23° C.

8. A process for producing the polyisocyanate composition according to claim 1, wherein at least 1,5-diisocyanatopentane is mixed with at least linear, branched, and optionally substituted monoalcohol which is inert in the side chain toward isocyanate groups, and wherein reaction is carried out in the presence of a catalyst to give the polyisocyanate composition.

9. The process according to claim 8, wherein the reaction is carried out at temperatures between ≧0 and ≦180° C.

10. The process according to claim 8, wherein the 1,5-diisocyanatopentane is obtained by phosgenation of 1,5-diaminopentane in the gas phase.

11. A two-component system comprising a component A), comprising at least one polyisocyanate composition according to claim 1, and a component B), comprising at least one binder that is reactive toward isocyanate groups.

12. The two-component system according to claim 11, wherein the binder that is reactive toward isocyanate groups comprises at least one hydroxy-functional compound having a hydroxyl group content of ≧5.0 wt %, content of the binder that is reactive toward isocyanate groups.

13. A method of producing a coating on a substrate comprising including the two-component system according to claim 11.

14. A coating obtained by the method according to claim 13.

15. An assembly composed of a coating according to claim 14 and a substrate having a surface of metal and/or plastic.
